(19) United States
(12) Patent Application Publication
(10) Pub. No.: US 2006/0193683 A1
(43) Pub. Date: Aug. 31, 2006

(54) Shaft and shaft molding device

(75) Inventors: Tsugio Yokoo, Gunma (JP); Yoshihiro Nanba, Gunma (JP)

Correspondence Address: MCCORMICK, PAULDING & HUBER LLP, CITY PLACE II, 185 ASYLUM STREET, HARTFORD, CT, 06103, US

(73) Assignee: MITSUBA Corporation, Kiryu-shi (JP)

(21) Appl. No.: 10/546,622

(22) PCT Filed: Feb. 27, 2004
(86) PCT No.: PCT/JP04/02363

§ 371 Date: Aug. 22, 2005

(30) Foreign Application Priority Data
Feb. 27, 2003 (JP) 2003-050726

(51) Int. Cl. B25G 3/00

(52) U.S. Cl. 403/256

(57) ABSTRACT

Four knurls are formed by a molding apparatus (31) to be evenly spaced circumferentially on and protrude from an outer circumferential surface of an armature shaft (14). The molding apparatus (31) has a first mold (32) and a second mold (33), which are movable in directions of being close to and separating from each other, wherein the first mold (32) is provided with a pair of first molding edges (43) and the second mold (33) is provided with a pair of second molding edges (45). The respective molding edges (43) and (45) are formed into parallelogram sections, which have cutting faces (51) and (61) parallel to a moving direction of the second mold (33), extrusion faces (52) and (62) formed at acute angels with respect to the cutting faces (51) and (61), and load supporting faces (53) and (63) parallel to the extrusion faces (52) and (62). By pressing those molding edges (43) and (45) against the outer circumferential surface of the armature shaft (14), the knurls is formed.

### CROSS-REFERENCE TO RELATED APPLICATIONS

This application is entitled to the benefit of and incorporates by reference essential subject matter disclosed in International Patent Application No. PCT/JP2004/002363 filed on Feb. 27,2004 and Japanese Patent Application No. 2003-050726 filed on Feb. 27, 2003.

### FIELD OF THE INVENTION

The present invention relates to a shaft, which has knurls formed for being firmly fitted/fixed to a member to be fitted on an outer circumferential surface of the shaft.

### BACKGROUND OF THE INVENTION

Since conventionally, a method of press-inserting a shaft into a fit hole formed in a member to be fitted and fitting/fixing the member to be fitted to the shaft has been known. However, in such a method, since an inner diameter of the fit hole is formed slightly larger than an outer diameter of the shaft, firmly fixing is different. Therefore, the conventional fixing method is such that a plurality of strips of knurls, each of which protrudes from an outer circumferential surface of the shaft to a predetermined height and extends axially, are formed, whereby a fit strength thereof is improved.

For example, four strips of knurls are formed on an outer circumferential surface of an armature shaft of a brush-equipped electric motor, and a commutator obtained by forming a conductive member made of a copper plate etc. into an annular shape in an insulative state by an insulative member made of a resin material is fitted/fixed to the outer circumferential surface of the armature shaft in portions where those knurls are formed. Further, when a resin part of the commutator is press-inserted into the armature shaft, the knurls become elastically deformed in a radial direction, thereby being firmly fitted to the commutator due to their elastic forces.

In this case, the armature shaft is in a state where an armature core is preliminarily fixed, and after the knurls have been formed by a molding apparatus in such a state, the commutator is press-inserted into the armature shaft. Then, armature coils are wound around the armature core, and each tip of the armature coils is connected to the commutator. Thereafter, a coating is subjected to the armature coils, and finally an outer circumferential surface of the commutator is cutting-processed to remove a coating material leaking in the outer circumferential surface of the commutator.

The molding apparatus of the shape, which is used to form such knurls, has been known as a molding apparatus in which a pair of molding edges are fixed in a predetermined interval to each of an upper mold and a lower mold attached to a hydraulic pressing apparatus and the knurls are formed by pressing the molding edges against the shaft placed between those molds, for example as shown in Japanese Patent Laid-open Publication No. 5-200475. In this case, each molding edge is formed into a substantially square section, which has a cutting face parallel to a movement direction of the upper mold and an extrusion face formed orthogonally to this cutting face, and the respective extrusion faces are parallel to each other. Further, by those molding edges, the outer circumferential surface of the shaft is broken down and overhangs radially, whereby the knurls are formed.

However, such a molding apparatus needs a heavy processing load since the extrusion face of each molding edge is formed orthogonally to the cutting face. Particularly, when a distance between the adjacent molding edges is set short, an angle formed between each extrusion face and the outer circumferential surface of the shaft becomes small and thereby an excessive processing load becomes necessary. According to circumstances, it is feared that the shaft itself is altered and roundness of the shaft is lowered.

Therefore, in the conventional molding apparatus, the distance between the adjacent molding edges is set large to a certain extent, whereby the angle formed between each extrusion face and the outer circumferential surface of the shaft is made large to reduce the processing load.

However, in this case, two knurls formed by the molding edges of the upper mold are each formed with a phase difference of, for example, approximately 105 degrees to 110 degrees, and the knurls formed by the molding edges of the lower mold are each formed with a phase difference of, for example, approximately 105 degrees to 110 degrees. That is, the knurls are formed to be biased on both radial sides of the shaft. For this reason, elastic forces of the knurls are applied to the commutator at positions biased to radial-directional both ends thereof, and its section is deformed into an ellipse, whereby the roundness is lowered. Additionally, when the commutator is deformed into an ellipse, cutting margins change in cutting the outer circumferential surface and therefore there is a problem of an occurrence etc. of cutting remains of the coating material.

Moreover, by biases of positions of the knurls, a weight balance of the shaft itself is biased, and this becomes a cause for an occurrence of vibrations generated in rotating the armature shaft.

An object of the present invention is to ensure the roundness of the member to be fitted, which is fitted/fixed to the shaft.

Another object of the present invention is to reduce the processing load involved in forming the knurls.

### BRIEF SUMMARY OF THE INVENTION

A shaft according to the present invention, on an outer circumferential surface of which knurls are formed by first and second molds provided relatively movably in directions of being close to and separating from each other and to which a member to be fitted having a fit hole is fitted/fixed, comprises: a pair of first knurls formed by a pair of first molding edges, each having a cutting face formed in parallel to a relatively moving direction and an extrusion face formed at an acute angle with respect to said cutting face and provided in said first mold so as to oppose to said cutting face and be disposed at a predetermined interval; and a pair of second knurls formed by a pair of second molding edges, each having a cutting face formed in parallel to a relatively moving direction and an extrusion face formed at an acute angle with respect to said cutting face and provided in said second mold so as to oppose to said cutting face and be disposed at a predetermined interval, wherein four strips of said knurls are formed so as to be evenly spaced circumferentially.

The shaft according to the present invention is such that vertexes of said knurls are evenly spaced circumferentially.

The shaft according to the present invention is such that the pair of said first molding edges contact at an interval of circumferentially falling within a range of 90 degrees, the pair of said second molding edges contact at an interval of circumferentially falling within a range of 90 degrees, and thereby the four strips of said knurls are formed so as to be evenly spaced circumferentially.

The shaft according to the present invention is such that axial-directional lengthwise dimensions of said first and second knurls are set longer than that of said member to be fitted.

The shaft according to the present invention is such that an inner diameter of said fit hole is set larger than an outer diameter of said shaft, and said member to be fitted is fitted/fixed to said first and second knurls.

The shaft according to the present invention further comprises: a pair of third knurls circumferentially displaced by 45 degrees from said first knurls and formed by said first molding edges; and a pair of fourth knurls circumferentially displaced by 45 degrees from said second knurls and formed by said second molding edges, wherein eight strips of said knurls are formed so as to be evenly spaced circumferentially.

The shaft according to the present invention is such that said member to be fitted is a commutator used for an electric motor.

A molding apparatus of a shaft according the present invention, to which a member to be fitted having a fit hole is fitted/fixed, comprises: first and second molds provided relatively movably through said shaft in directions of being close to and separating from each other, a pair of first molding edges each having a cutting face formed in parallel to a relatively moving direction and an extrusion face formed at an acute angle with respect to said cutting face and provided in said first mold so as to oppose to each other and arranged in a predetermined interval; and a pair of second molding edges each having a cutting face formed in parallel to a relatively moving direction and an extrusion face formed at an acute angle with respect to said cutting face and provided in said second mold so as to oppose to each other and arranged in a predetermined interval, wherein a knurl is formed on an outer surface of said shaft by pressing said first and second molding edges against the outer circumferential surface of said shaft.

The molding apparatus of a shaft according to the present invention is such that the pair of said first molding edges contact with the outer circumferential surface of said shaft at an interval of circumferentially falling within a range of 90 degrees, the pair of said second molding edges contact with the outer circumferential surface of said shaft at an interval of circumferentially falling within a range of 90 degrees, and thereby the four strips of said knurls are formed so as to be evenly spaced circumferentially.

The molding apparatus of a shaft according to the present invention is such that said first and second molding edges are formed into parallelogram sections, which have load supporting faces formed in parallel to said extrusion faces, and said first and second molding edges are fixed to groove portions provided in said first and second molds.

Thus, according to the present invention, since the knurls are circumferentially provided evenly, the roundness of the member to be fitted, which is fitted/fixed to the shaft, can be ensured.

Additionally, according to the present invention, since the extrusion face formed in the molding edge is formed at the acute angle with respect to the cutting face, the reaction force applied to the extrusion face is dispersed into a moving direction of each molding edge and a direction orthogonal to the moving direction, whereby the processing loads required in forming the knurls can be reduced.

Further, according to the present invention, since the processing loads can be reduced, the interval between the molding edges provided in the first and second molds can be narrowed up to a predetermined value, so that the knurls can be circumferentially formed evenly.

Further, according to the present invention, the member to be fitted is fixed to the shaft by the loose fit without being press-inserted, so that even if variations of positions of the respective knurls occur, the member to be fitted is automatically aligned and thereby vibrations etc. occurring in rotation can be reduced. Also, since damages such as abrasion caused in press-inserting the shaft into the fit hole of the member to be fitted are reduced, endurance of the member to be fitted can be enhanced.

Further, according to the present invention, since the lengthwise dimension of the knurl is formed longer than that of the member to be fitted, the member to be fitted can be certainly fixed to the shaft in fixing, to the shaft particularly by the loose fit, the member to be fitted.

Further, according to the present invention, since the eight strips of knurls are circumferentially arranged and disposed, the fixing strength thereof can be improved while the roundness of the member to be fitted is maintained. Also, after the four strips of knurls are formed, the shaft is circumferentially rotated by 45 degrees and is processed again, so that the eight strips of knurls can be easily formed.

Further, according to the present invention, since the positions of the pair of molding edges adjacent to each other with respect to the shaft can be easily matched, accuracy of assembling the molding apparatus of the shaft can be improved.

Further, according to the present invention, since the knurls are circumferentially formed evenly, a section of the shaft becomes a substantially complete-round shape, so that variations of the loads applied to the member to be fitted in press-inserting the shaft can be decreased.

### BRIEF DESCRIPTION OF THE DRAWINGS

FIG. 1 is a cross-sectional view schematically showing an electric motor provided with an armature shaft according to an embodiment of the present invention.

FIG. 2 is a perspective view showing a state of press-inserting a commutator into the armature shaft.

FIG. 3 is a cross-sectional view taken along line 3-3 in FIG. 2.

FIG. 4 is a cross-sectional view showing lengthwise dimensions of a commutator and a knurl.

FIG. 5 is a cross-sectional view taken along line 5-5 in FIG. 4.

FIG. 6 is a front view showing a molding apparatus of a shaft.

FIG. 7 is a cross-sectional view taken along line 7-7 in FIG. 6.

FIG. 8 is a cross-sectional view showing an enlarged principal portion of the molding apparatus of a shaft illustrated in FIG. 7.

FIG. 9 is a cross-sectional view showing a method of polishing molding edges.

FIG. 10 is a cross-sectional view showing a modifying example of the armature shaft illustrated in FIG. 3.

### DETAILED DESCRIPTION OF THE INVENTION

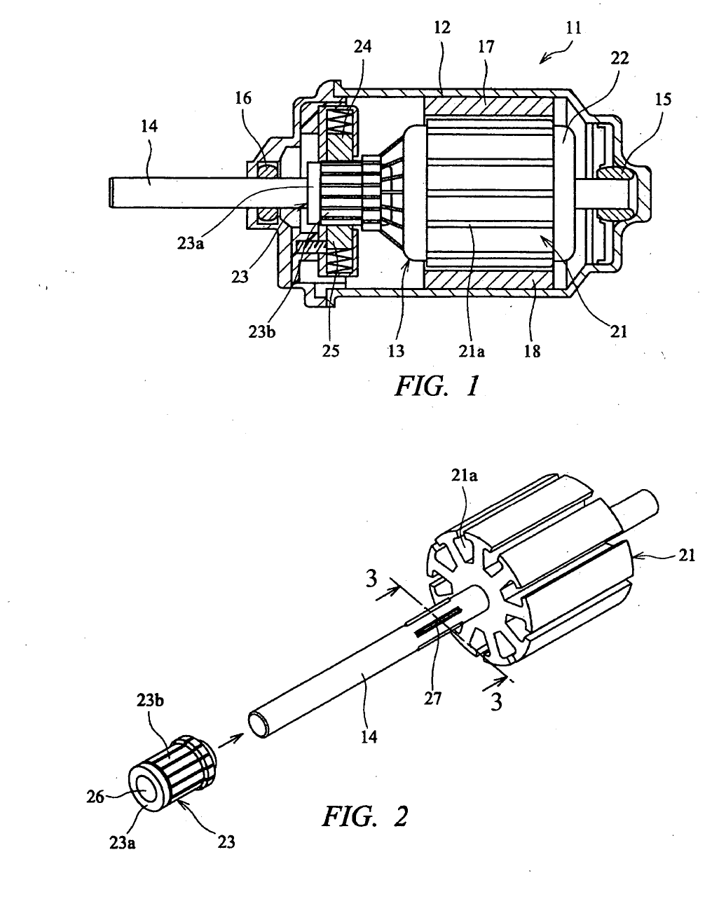

As shown in FIG. 1, an electric motor 11 has an armature 13 accommodated in a motor housing 12.

The armature 13 is made of steel and has an armature shaft 14 serving as a shaft formed into a substantially circular and uniform section and this armature shaft 14 is supported by bearings 15 and 16, thereby becoming rotatable inside the motor housing 12.

An armature core 21, which is located within a magnetic field created by a pair of permanent magnets 17 and 18 fixed to the motor housing 12, is fixed to the armature shaft 14. An armature coil 22 is wound around each of a plurality of slots 21 a formed in the armature core 21.

Also, a commutator serving as a member to be fitted is fixed to the armature shaft 14. The commutator 23 comprises: a body portion 23a made of a resin; and a plurality of commutator segments 23b arranged radially on and fixed to an outer circumferential surface of the body portion 23a, wherein the armature coil 22 is connected to each of those commutator segments 23b. Further, when a current is supplied to a pair of brushes 24 and 25 slidably contacting with the commutator 23, the current is commutated by the commutator 23 and supplied to the armature coil 22, so that a rotational force of the armature 13 is generated. In this case, if a member to be driven is connected to a portion protruding from the motor housing 12 of the armature shaft 14 to the outside, an output of this electric motor 11 is transmitted to the member to be driven.

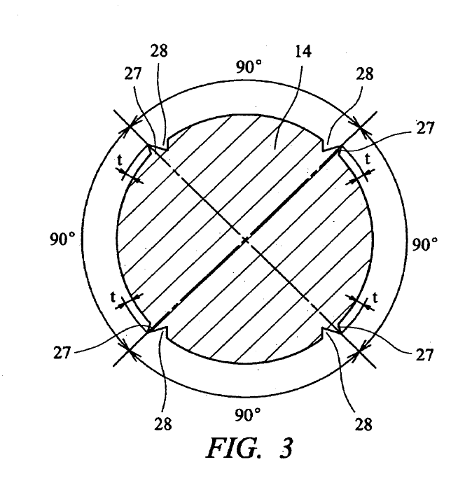

As shown in FIG. 2, the body portion 23a of the above-mentioned commutator 23 is provided with a fit hole 26 formed with a diameter slightly larger than an outer diameter of the armature shaft 14. Further, when being inserted into the armature shaft 14 within the fit hole 26, the commutator 23 is fixed to the armature shaft 14.

Additionally, in order to improve a fixing strength along with the commutator 23, four strips of knurls 27 protruding from the outer circumferential surface of the armature shaft 14 are formed on the outer circumferential surface of the armature shaft 14. As shown in FIG. 3, each knurl 27 is formed so as to protrude from the outer circumferential surface of the armature shaft 14 and have a predetermined height “t”, and a groove portion 28 is formed at each position adjacent to those knurls 27. Additionally, the respective knurls 27 are arranged so as to be circumferentially displaced from each other per phase of 90 degrees, i.e., so that respective vertexes of the knurls 27 are evenly spaced circumferentially. Note that those knurls include a pair of first knurls 27 adjacent to each other and a pair of second knurls 27 adjacent to each other.

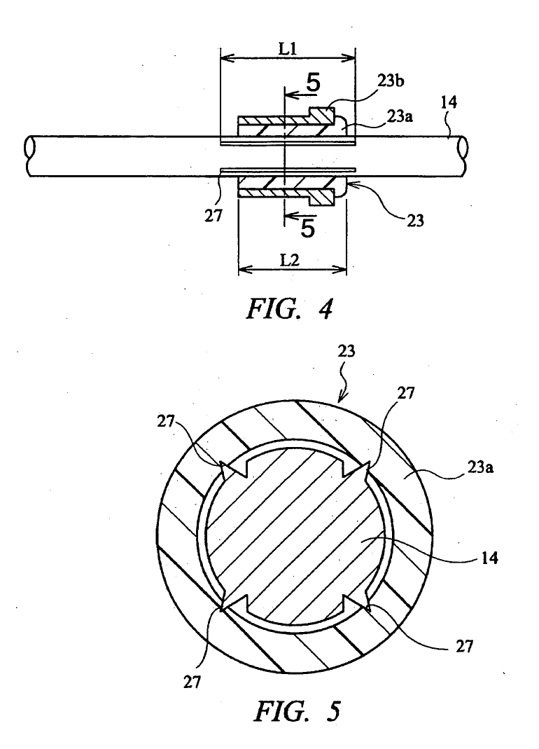

As seen also from FIG. 4, each of those knurls 27 is formed so as to extend along an axial direction of the armature shaft 14, and its axial-directional lengthwise dimension “L1” is formed longer than an axial-directional lengthwise dimension “L2” of the commutator 23. Further, the armature 23 is inserted into the armature shaft 14 so as to be engaged with the knurls 27 throughout an entirety of a longitudinal region of the fit hole 26.

Additionally, as shown in FIG. 5, since the fit hole 26 is formed with a diameter slightly larger than the outer diameter of the armature shaft 14, the commutator 23 is not press-inserted into the armature shaft 14 and is fitted/fixed to the respective knurls. That is, since loads are applied from those knurls in a direction of pushing and widening the fit hole 26, the commutator 23 is elastically deformed radially and concurrently the knurls 27 are elastically deformed circumferentially by the commutator 23, whereby the commutator 23 is firmly fixed to the armature shaft 14 due to the elastic forces of those elastic deformations.

Thus, the commutator 23 is engaged with the knurls 27 throughout the entirety of the longitudinal region of the fit hole 26 and is fixed to the armature shaft due to loose fit fitted only in those knurls 27, whereby movement in thrust and radial directions thereof is restricted by the knurls 27.

At this time, since those knurls 27 are formed on the outer circumferential surface of the armature shaft 14 so as to be evenly spaced circumferentially, the elastic forces applied to the commutator 23 by those knurls 27 are also evenly spaced circumferentially and, for example, the commutator 23 is not formed into an ellipse etc. That is, by providing the knurls 27 circumferentially and evenly, the roundness of the commutator 23 is ensured.

Thus, since the four strips of knurls 27 are formed on the armature shaft 14 so as to be evenly spaced circumferentially and protrude therefrom, the roundness of the commutator 23 fitted/fixed to the armature shaft 14 can be ensured.

Additionally, the commutator 23 is fixed to the armature shaft 14 and connected to the armature core 22 and thereafter is cutting-processed in order to remove the coating material attached to its outer circumferential surface. However, at this time, since the roundness is ensured, the cutting margin becomes circumferentially constant and the cutting remains of the coating material are not generated.

Further, in the armature shaft 14, the commutator 23 is subjected to the loose fit with respect to the armature shaft 14, so that even if variations of positions of the respective knurls 27 occur, the commutator 23 moves to an extent of a clearance between it and the armature shaft 14 and is aligned automatically. Therefore, vibrations etc. generated when the armature shaft 14 to which the commutator 23 is fitted/fixed is rotated can be reduced. Additionally, damages such as abrasion occurring in inserting the armature shaft 14 into the fit hole 26 of the commutator 23 are reduced, whereby endurance of the commutator 23 can be improved.

Further, in the armature shaft 14, the lengthwise dimension “L1” of the knurl 27 is formed longer than the lengthwise dimension “L2” of the commutator 23, so that since the commutator 23 is engaged with the knurls 27 throughout the entirety of the longitudinal region of the fit hole 26, the commutator 23 can certainly be fixed to the armature shaft 14.

Next, a description will be made of a molding apparatus of a shaft for forming those knurls 27 on the outer circumferential surface of the armature shaft 14.

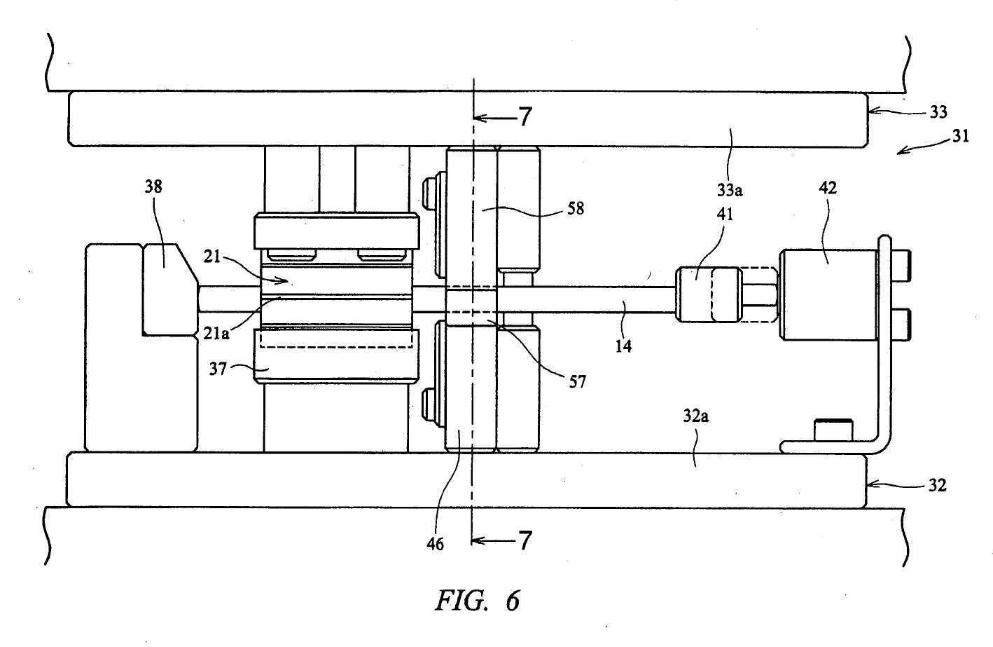

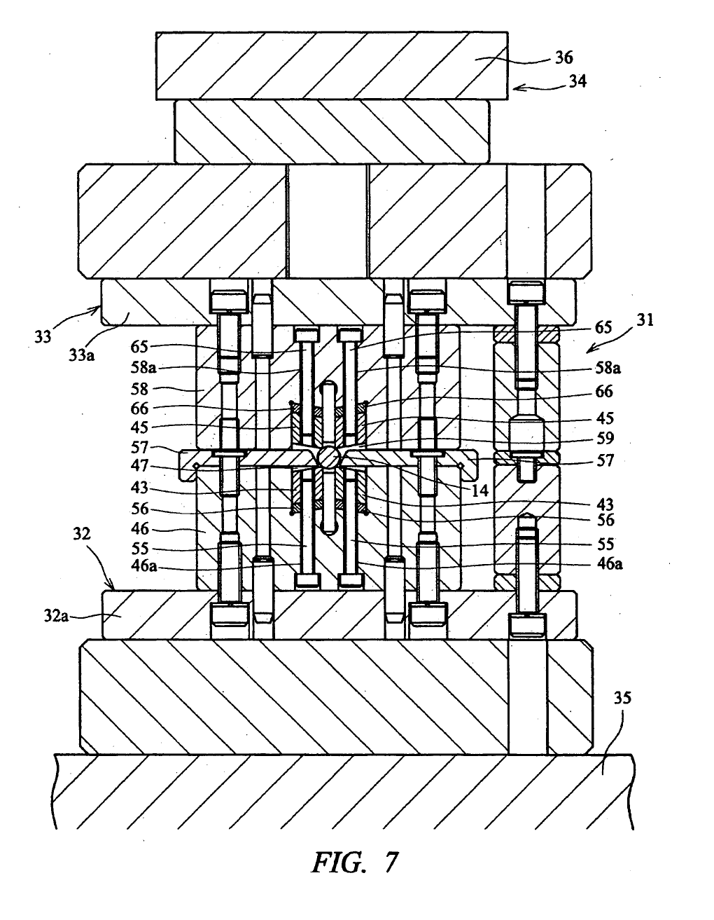

As shown in FIGS. 6 and 7, a molding apparatus 31 of a shaft (hereinafter abbreviated as “molding apparatus 31”) has a first mold 32 and a second mold 33, wherein the first mold 32 is fixed to a bolster of a hydraulic pressing apparatus 34 and the second mold 33 is fixed to a ram 36 of the hydraulic pressing apparatus 34. As the hydraulic pressing apparatus 34, although being not illustrated in detail, a well-known apparatus in which the ram 36 moves vertically toward the bolster 35 by hydraulic pressure has been used since conventionally.

When the knurls 27 are formed on the armature shaft 14 by the molding apparatus 31, the armature shaft 14 is placed on the first mold 32 in a state of being preliminarily fixed to the armature core 21 in order to improved accuracy of assembling the armature 13. A support table 37 formed into a substantially C-shape section is fixed to a base plate 32a of the first mold 32, and the armature shaft 14 is located in a state in which the armature core 21 is supported by the support table 37. Also, a positioning block 38 and a positioning piece 41 are provided over the base plate 32a, and the armature shaft 14 is axially positioned by being sandwiched between the positioning block 38 and the positioning piece 41. Note that the positioning piece 41 is driven by an actuator 42 and becomes movable axially, thereby moving from a releasing location shown by the dashed lines of FIG. 6 to a fixing location shown by the solid line thereof when the armature shaft 14 is positioned.

The first mold 32 and the second mold 33 can be relatively moved through the armature shaft 14 in directions of being close to and separating from each other, i.e., since the ram 36 moves vertically, the second mold 33 moves in the directions of being close to and separating from the first mold 32. Although the Figure is illustrated so that the second mold 33 can moves in the directions of being close to and separating from the first mold 32 by using the hydraulic pressing apparatus 34, this embodiment is not limited to such movement. If being able to make the first mold 32 and the second mold 33 relatively move through the armature shaft 14 in the directions of being close to and separating form each other, another apparatus may be used.

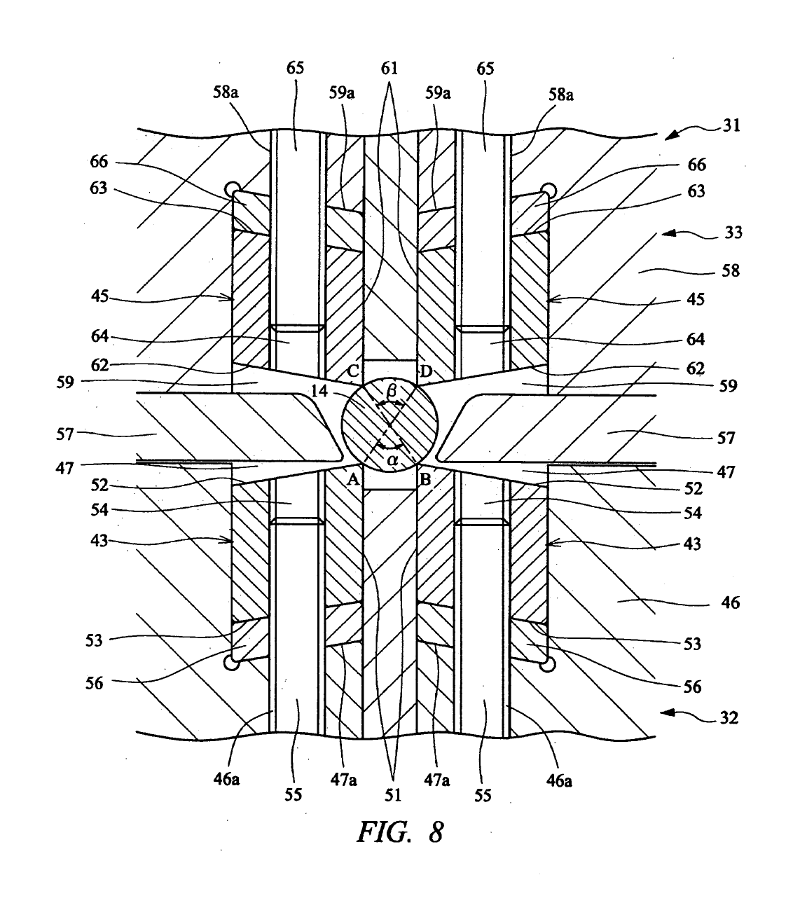

As shown in FIG. 8, a pair of first molding edges 43, which are symmetrically arranged with respect to an axial center of the armature shaft 14 in order to form a first knurl 27 (hereinafter abbreviated as “knurl 27”), are provided to the first mold 32, and a pair of second molding edges 45, which are symmetrically arranged with respect to the axial center of the armature shaft 14 in order to form a second knurl 27 (hereinafter abbreviated as “knurl 27”), are provided to the second mold 33.

The base plate 32a of the first mold 32 has a holder block 46, and the first molding edges 43 are accommodated in groove portions 47 formed in the holder block 46, respectively.

The first molding edge 43 is formed in a parallelogram section, which has a cutting face 51 formed in parallel to a moving direction of the second mold 33, an extension face 52 formed to have an acute angle with respect to the cutting face 51, and a load supporting face 53 formed in parallel to the extension face 52 and at an axial center of which a screw hole 54 for fix is provided. Also, a bolt 55 inserted into a through hole 46a formed in the holder block 46 is screw-connected to the screw hole 54, whereby the first molding edge 43 is fixed in the groove portion 47. Additionally, a bottom face 47a of the groove portion 47 inclines so as to correspond to the load supporting face 53 and is formed, and a spacer 56 formed into a parallelogram section is attached between the bottom face 47a and the load supporting face 53. Note that the reference numeral “57” shows a rough guide for roughly positioning the armature shaft 14 in being disposed on the first mold 32.

Then, the pair of first molding edges 43 are disposed so that the cutting faces 51 are opposed to each other and arranged at a predetermined interval, and the interval is narrowly set to such an extent that the knurls 27 formed on the armature shaft 14 circumferentially have a phase difference of 90 degrees. That is, as shown in FIG. 8, contact points “A” and “B” where the pair of first molding edges 43 contact respectively with the outer circumferential surface of the armature shaft 14 are set so that an angle “a” circumferentially formed between the points by regarding the axial center of the armature shaft 14 as a center falls within a range of 90 degrees (so as to become 80 degrees in the Figure). For this reason, the pair of first molding edges 43 contact with the outer circumferential surface of the armature shaft 14 at an interval of circumferentially falling within the range of 90 degrees.

Meanwhile, a base plate 33a of the second mold 33 has a holder plate 58 and the second molding edges 45 are accommodated in groove portions 59 formed in the holder block 58, respectively.

Similarly to the first molding edge 43, the second molding edge 45 is formed into a parallelogram section, which has a cutting face 61 formed in parallel to a moving direction of the second mold 33, an extrusion face 62 formed to have an acute angle with respect to the cutting face 61, and a load supporting face 63 formed in parallel to the extrusion face 62 and at an axial center of which a screw hole 64 for fix is provided. Also, a bolt 65 inserted into a through hole 58a formed in the holder block 58 is screw-connected to the screw hole 64, whereby the second molding edge 45 is fixed to the groove portion 59. Additionally, a bottom face 59a of the groove portion 59 inclines so as to correspond to the load supporting face 63 and is formed, and a spacer 66 formed into a parallelogram section is attached between the bottom face 59a and the load supporting face 63.

Then, the pair of second molding edges 45 are disposed so that the cutting faces 61 are opposed to each other and arranged at a predetermined interval, and the interval is narrowly set to such an extent that the knurls 27 formed on the armature shaft 14 by the second molding edges 45 can have circumferentially a phase difference of 90 degrees. That is, as shown in FIG. 8, contact points “C” and “D” where the second molding edges 45 contact respectively with the outer circumferential surface of the armature shaft 14 are set so that an angle “β” circumferentially formed between the points by regarding the axial center of the armature shaft 14 as a center falls within a range of 90 degrees (so as to become 80 degrees in the Figure). For this reason, the pair of second molding edges 43 contact with the outer circumferential surface of the armature shaft 14 at an interval of circumferentially falling within the range of 90 degrees. Also, an interval between the pair of second molding edges 45 is set to be identical to that between the pair of first molding edges 43.

When the second mold 33 is driven by the ram 36 and moves to the closest position to the first mold 32, i.e., a bottom dead center, the respective molding edges 43 and 45 are simultaneously pressed against the outer circumferential surface of the armature shaft 14 in a state of applying the processing load thereto. Then, the respective molding edges 43 and 45 pressed against the outer circumferential surface of the armature shaft 14 break down the outer circumferential surface and make it overhang radially, thereby forming the knurls 27 on the outer circumferential surface.

At this time, since the extrusion faces 52 and 62 of the respective molding edges 43 and 45 are formed at the acute angles with respect to the cuffing faces 51 and 61, reaction forces applied to the extrusion faces 52 and 62 from the armature shaft 14 during processing are dispersed into a moving direction of each of the molding edges 43 and 45 and a direction orthogonal to the moving direction, whereby the processing loads required in order that the respective molding edges 43 and 45 form the knurls 27 are reduced. Additionally, the pair of first molding edges 43 contact mutually with the armature shaft 14 at the interval of circumferentially falling within the range of 90 degrees, whereby a circumferential interval between the knurls 27 to be formed can be set at an angle of 90 degrees.

Thus, in the molding apparatus 31, since the extrusion faces 52 and 62 formed in the respective molding edges 43 and 45 are formed at the acute angles with respect to the cutting faces 51 and 61, the processing loads required in forming the knurls 27 can be reduced.

Also, in the molding apparatus 31, the extrusion faces 52 and 62 formed in the respective molding edges 43 and 45 are formed at the acute angles with respect to the cutting faces 51 and 61 and thereby the processing loads required in forming the knurls 27 can be reduced, so that even if the interval between the first molding edges 43 is set narrowly and the interval between the second edges 45 is set narrowly, the armature shaft 14 itself cannot be deformed due to the processing loads. Therefore, by setting narrowly the interval between the first molding edges 43 to such an extent that the knurls 27 are circumferentially formed with a phase difference of 90 degrees and by setting narrowly the interval between the second molding edges 45 to such an extent that the knurls 27 are circumferentially formed with a phase difference of 90 degrees, as shown in FIG. 3, the four strips of knurls 27 evenly spaced circumferentially on and protruding from the outer circumferential surface of the armature shaft 14 can be formed.

Thus, in the molding apparatus 31, since the processing loads required in forming the knurls 27 can be reduced, the interval between the molding edges 43 and 45 provided in the first mold 32 and the second mold 33 is narrowed up to a predetermined value and the four strips of knurls 27 evenly spaced circumferentially on and protruding from the outer circumferential surface of the armature shaft 14 can be formed.

Further, as shown in FIG. 3, the knurls 27 manufactured by the molding apparatus 31 are each formed into an acuter-angled triangle, for example in comparison with knurls formed by the molding edges in which the extrusion faces 52 and 62 are formed orthogonally to the cutting faces 51 and 61, so that even if both heights “t” is the same, its area becomes smaller. For this reason, those knurls 27 are easily deformed elastically in a radial direction, and the elastic force for deforming the commutator 23 becomes small. Accordingly, the deformation of the commutator is smaller, whereby its roundness can be ensured.

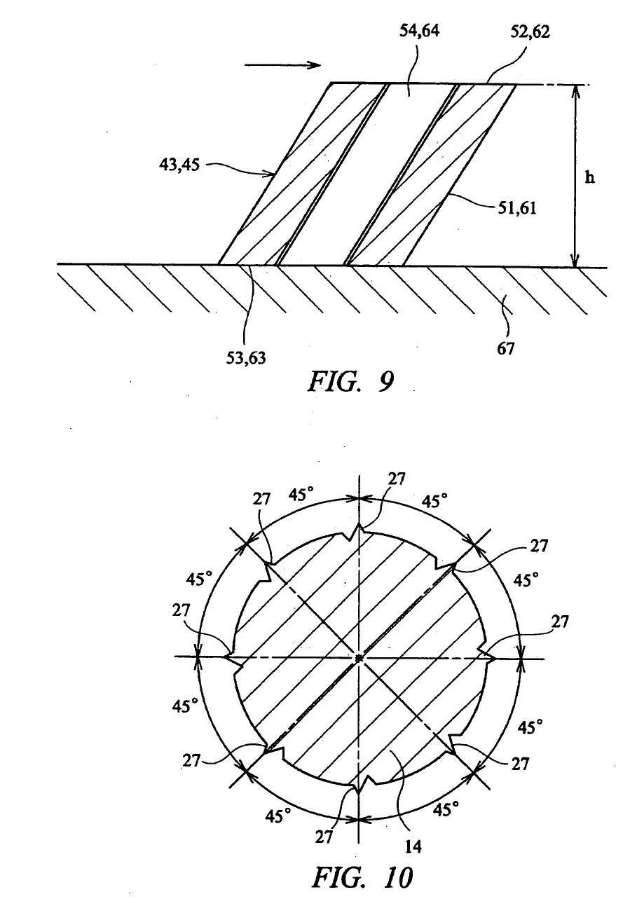

Additionally, in the molding apparatus 31, if the respective molding edges 43 and 45 degenerate in cutting due to an occurrence of abrasion etc., the respective molding edges 43 and 45 are detached by releasing fastening of the bolts 55 and 65 and their extrusion faces 52 and 62 are cut and ground. However, at this time, since the extrusion faces 52 and 62 and the load supporting faces 53 and 63 are formed parallel, as shown FIG. 9, the load supporting faces 53 and 63 are disposed so as to be tangent to the a grinding table 67 and the extrusion faces 52 and 62 are ground. Thereby, intervals “h” between the extrusion faces 52 and 62 and the load supporting faces 53 and 63 of the respective molding edges 43 and 45 after being ground can be easily matched. That is, since the intervals “h” between the extrusion faces 52 and 62 and the load supporting faces 53 and 63 are matched, each shape of the molding edges 43 and 45 can be easily matched. Additionally, by using the spacers 56 and 66 of which each width corresponds to a ground amount, positions of the pair of molding edges 43 and 45 adjacent to each other with respect to the armature shaft 14 can be easily matched. Therefore, when the second mold 33 moves toward the first mold 32, the adjacent molding edges 43 and 45 are simultaneously tangent to the outer circumferential surface of the armature shaft 14, whereby the processing loads can be evenly exerted on the respective molding edges 43 and 45 and the processing accuracy of the molding apparatus 31 can be improved.

Thus, in the molding apparatus 31, since the positions of the pair of molding edges 43 and 45 adjacent to each other with respect to the armature shaft 14 can be easily matched, the processing accuracy of the molding apparatus 31 can be improved.

Needless to say, the present invention is not limited to the above-mentioned embodiments and may be variously modified and altered without departing from the gist thereof. For example, although the knurls 27 for fitting/fixing the commutator 23 to the outer circumferential surface of the armature shaft 14 are formed, the above embodiment is not limited to this case. If the member to be fitted in which the fit hole is formed is fitted/fixed to another shaft, such a shaft may be applied.

Additionally, although the four strips of knurls 27 are formed on the armature shaft 14, the above embodiment is not limited to this case. For example, as shown in FIG. 10, the first knurls 27 and the second knurls 27 are formed by the molding apparatus 31, and thereafter the armature shaft 14 is circumferentially rotated by an angle of 45 degrees and is processed again by the molding apparatus 31. Thereby, a third knurls circumferentially displaced by 45 degrees from the first knurls 27 and formed by the first molding edges 43 and a fourth knurls circumferentially displaced by 45 degrees from the second knurls 27 and formed by the second molding edges 45, i.e., a total of eight strips of knurls may be formed so as to be evenly spaced circumferentially.

The present invention can be applied in fixing a member to be fitted such as a commutator to a shaft such as an armature shaft of an electric motor.

While the present invention has been illustrated and described with respect to a particular embodiment thereof, it should be appreciated by those of ordinary skill in the art that various modifications to this invention may be made without departing from the spirit and scope of the present invention.

1. A shaft, on an outer circumferential surface of which knurls are formed by first and second molds provided relatively movably in directions of being close to and separating from each other and to which a member to be fitted having a fit hole is fitted/fixed, comprising:
a pair of first knurls formed by a pair of first molding edges, each having a cutting face formed in parallel to a relatively moving direction and an extrusion face formed at an acute angle with respect to said cutting face and provided in said first mold so as to oppose to said cutting face and be disposed at a predetermined interval; and
a pair of second knurls formed by a pair of second molding edges, each having a cutting face formed in parallel to a relatively moving direction and an extrusion face formed at an acute angle with respect to said cutting face and provided in said second mold so as to oppose to said cutting face and be disposed at a predetermined interval,
wherein four strips of said knurls are formed so as to be evenly spaced circumferentially.

2. The shaft according to claim 1, wherein vertexes of said knurls are evenly spaced circumferentially.

3. The shaft according to claim 1, wherein the pair of said first molding edges contact at an interval of circumferentially falling within a range of 90 degrees, the pair of said second molding edges contact at an interval of circumferentially falling within a range of 90 degrees, and thereby the four strips of said knurls are formed so as to be evenly spaced circumferentially.

4. The shaft according to claim 1, wherein axial-directional lengthwise dimensions of said first and second knurls are set longer than that of said member to be fitted.

5. The shaft according to claim 1 wherein an inner diameter of said fit hole is set larger than an outer diameter of said shaft, and said member to be fitted is fitted/fixed to said first and second knurls.

6. The shaft according to claim 1, further comprising:
a pair of third knurls circumferentially displaced by 45 degrees from said first knurls and formed by said first molding edges; and
a pair of fourth knurls circumferentially displaced by 45 degrees from said second knurls and formed by said second molding edges,
wherein eight strips of said knurls are formed so as to be evenly spaced circumferentially.

7. The shaft according to claim 1, wherein said member to be fitted is a commutator used for an electric motor.

8. A molding apparatus of a shaft to which a member to be fitted having a fit hole is fitted/fixed, the apparatus comprising:
first and second molds provided relatively movably through said shaft in directions of being close to and separating from each other,
a pair of first molding edges each having a cutting face formed in parallel to a relatively moving direction and an extrusion face formed at an acute angle with respect to said cutting face and provided in said first mold so as to oppose to each other and arranged in a predetermined interval; and
a pair of second molding edges each having a cutting face formed in parallel to a relatively moving direction and an extrusion face formed at an acute angle with respect to said cutting face and provided in said second mold so as to oppose to each other and arranged in a predetermined interval,
wherein a knurl is formed on an outer surface of said shaft by pressing said first and second molding edges against the outer circumferential surface of said shaft.

9. The molding apparatus of a shaft according to claim 8, wherein the pair of said first molding edges contact with the outer circumferential surface of said shaft at an interval of circumferentially falling within a range of 90 degrees, the pair of said second molding edges contact with the outer circumferential surface of said shaft at an interval of circumferentially falling within a range of 90 degrees, and thereby the four strips of said knurls are formed so as to be evenly spaced circumferentially.

10. The molding apparatus of a shaft according to claim 8, wherein said first and second molding edges are formed into parallelogram sections, which have load supporting faces formed in parallel to said extrusion faces, and
said first and second molding edges are fixed to groove portions provided in said first and second molds.
